(19) United States
(12) Patent Application Publication
(10) Pub. No.: US 2007/0112683 A1
(43) Pub. Date: May 17, 2007

(54) Method and system for extending access to a product

(75) Inventor: Paul Gleichauf, Saratoga, CA (US)

Correspondence Address: Trellis Intellectual Property Law Group, PC, 1900 EMBARCADERO ROAD, SUITE 109, PALO ALTO, CA, 94303, US

(73) Assignee: Cisco Technology, Inc., San Jose, CA (US)

(21) Appl. No.: 11/281,047

(22) Filed: Nov. 16, 2005

(51) Int. Cl. G06Q 99/00

(52) U.S. Cl. 705/59

(57) ABSTRACT

A method and system for managing payment for a license for a licensed product is provided. The method includes the use of regulations to enforce payment for the license that is issued to a client. The license is issued to the client by a license manager. The license manager informs the client if payment for the license is due. The client is instructed to make payment for the license by including payment for license in auditing functions of an auditor. Thereafter, the access expiration date of the licensed product is extended. The auditing functions include verification of the compliance of the client with the regulations. Thereafter, the client makes payment for the license.

### BACKGROUND OF THE INVENTION

1. Field of Invention

Embodiments of the invention relate in general to license management. More specifically, embodiments of the invention relate to methods and systems for extending access for a product.

2. Description of the Background Art

Software providers typically issue a license for a software product to a user. The license is an agreement between the software provider and the user, which allows the use of the licensed software product under conditions mentioned in the license. The license is issued to prevent unauthorized use of the licensed software product. For example, the user can be a business enterprise that has been issued the license for a fixed period of time, in which to use the services provided by the licensed software product. The user can use the licensed software product when the license is valid. Generally, the licensed software product ceases to function when the license expires. However, the license can be renewed when it expires. Once the license is renewed, the user can continue to use the licensed software product. The user can then use the licensed software product under the terms of the renewed license.

The licensed software product may be a critical product for the user. For example, the licensed software product may provide infrastructure services to the user. However, once the license expires, the licensed software product ceases to function and the services provided by the licensed software product will be deactivated. The deactivation of such a critical product can cause damage to the user. To prevent damage due to the expiration of the license, the user needs to renew the license, however, the user may require time to do this and may wish to continue using the critical product during such time.

According to a conventional technique, a warning message is issued to the user before the license expires. The warning message can indicate the expiration date of the license. However, once the license expires, the user is not authorized to continue using the licensed software product, even if it is a critical product for the user. The user can only use the licensed software product, when the license is renewed. In another conventional technique, the functions of the licensed software product are partially disabled when the license for the licensed software product expires.

### BRIEF DESCRIPTION OF THE DRAWINGS

FIG. 1 illustrates a network environment wherein various embodiments of the invention can be practiced.

FIG. 2 is a flowchart illustrating a method for managing the extension of an access expiration date of a licensed product, in accordance with various embodiments of the invention.

FIG. 3 illustrates a network environment wherein an embodiment of the invention can be practiced.

FIG. 4 is a flowchart illustrating a method for managing payment for a license, in accordance with an embodiment of the invention.

FIG. 5 illustrates a compliance server, in accordance with an embodiment of the invention.

FIG. 6 is a flowchart illustrating a method for communicating messages to extend an access expiration date of a licensed product, in accordance with an embodiment of the invention.

FIG. 7 is a flowchart illustrating a method for managing the use of a licensed product, in accordance with an embodiment of the invention.

### DETAILED DESCRIPTION OF EMBODIMENTS OF THE INVENTION

Embodiments of the invention provide methods, systems, and computer-readable medium for managing an extension of an access expiration date of a licensed product and for managing payment for a license for the licensed product. The licensed product is used on the basis of a set of terms and conditions mentioned in the license. The license is an agreement between a provider of the licensed product and its user. The license provides the user an authorization for using the licensed product. The user can use the licensed product, based on the set of terms and conditions mentioned in the license. The access expiration date of the licensed product is a date after which the user's access to the use of the licensed product expires. Generally, the access expiration date is the date on which the term of the license expires. Various embodiments of the invention provide a method and system for extending the access expiration date of the licensed product.

Various embodiments of the invention provide a method for a continuous use of the licensed product when payment for the license is due. The expiration date of the license and the extended access expiration date of the licensed product are communicated to an auditor responsible for auditing the user's records, such as the user's financial records. The auditor instructs the user to make payment for the license by including the payment for the license in its auditing functions. The auditing functions include verification of compliance of the user with regulations. Therefore, if the payment for the license is included in an audit trail, the auditing functions include reminding the user that payment for the license has to be made. In accordance with various embodiments of the invention, the user can use the licensed product even if the payment is due. Moreover, the user makes payment for the license and gets an extension of the access expiration date of the licensed product. Therefore, the user is able to use the licensed product for an extended time period when payment for the license is due. Further, the auditor can track the amount of payment for the use of the licensed product that the user has to make for an extended access time.

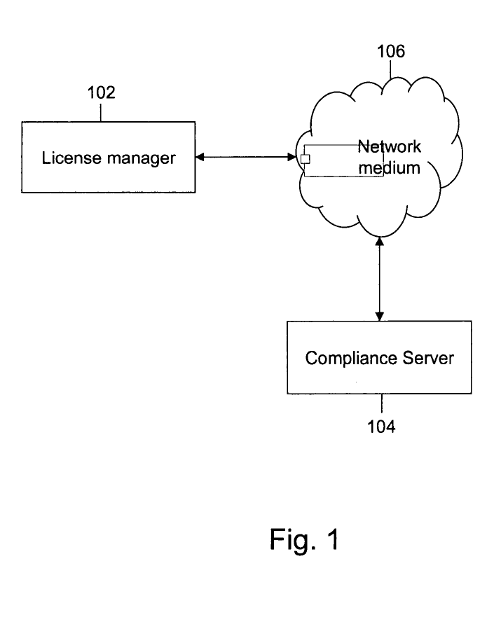

FIG. 1 illustrates a network 100 wherein various embodiments of the invention can be practiced. Examples of network 100 include, but are not limited to, an Internet, a Local Area Network (LAN), a Wide Area Network (WAN), a Metropolitan Area Network (MAN), and a Virtual Private Network (VPN). Network 100 includes a license manager 102, a compliance server 104, and a network medium 106. Network medium 106 is a medium for communication in network 100. According to various embodiments of the invention, network medium 106 may be a wired communication medium, a wireless communication medium, or a combination of the two.

According to various embodiments of the invention, license manager 102 manages the access to the licensed product. According to various embodiments of the invention, license manager 102 is located at the site of the provider. In an alternative embodiment of the invention, license manager 102 can be located at a separate location from the provider, and can be controlled by the provider. In one embodiment of the invention, license manager 102 can issue a license for a licensed product to a user. In an embodiment of the invention, the licensed product can be a licensed software product licensed out by a software provider. For example, license manager 102 can send an e-mail to the user, with an activation code to activate the licensed software product. Further, according to various embodiments of the invention, license manager 102 extends the access expiration date and sends the extended access expiration date to compliance server 104 over network medium 106. According to various embodiments of the invention, compliance server 104 is a server on network 100 that manages communication of information pertaining to the license. In accordance with various embodiments of the invention, compliance server 104 manages communication pertaining to the extension of the access expiration date of the licensed product.

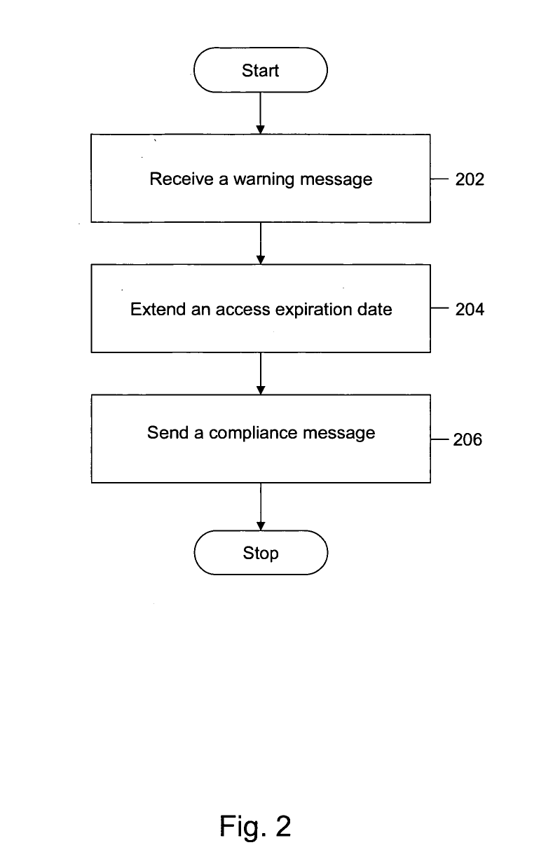

FIG. 2 is a flowchart illustrating the method to manage the extension of the access expiration date of the licensed product, in accordance with an embodiment of the invention. At step 202, compliance server 104 receives a warning message. In accordance with various embodiments of the invention, license manager 102 sends the warning message indicating that payment for the license is due. In an embodiment of the invention, the warning message includes the access expiration date of the licensed product. For example, license manager 102 can send an e-mail to compliance server 104 in which the access expiration date of the license is included. In accordance with an embodiment of the invention, the warning message includes the expiration date of the license. In an embodiment of the invention, the warning message is received on a date before the access expiration date. In an alternative embodiment of the invention, the warning message is received on the access expiration date. In another embodiment of the invention, the warning message is received on a date after the access expiration date. In accordance with an embodiment of the invention, compliance server 104 creates a log file when it receives the warning message. Accordingly, the log file indicates that compliance server 104 has received the warning message. According to various embodiments of the invention, the log file indicates the payment status of the licensed product. Compliance server 104 may further forward the warning message to the user or to an authorized entity. In an alternative embodiment of the invention, license manager 102 can send the warning message to the user or the authorized entity.

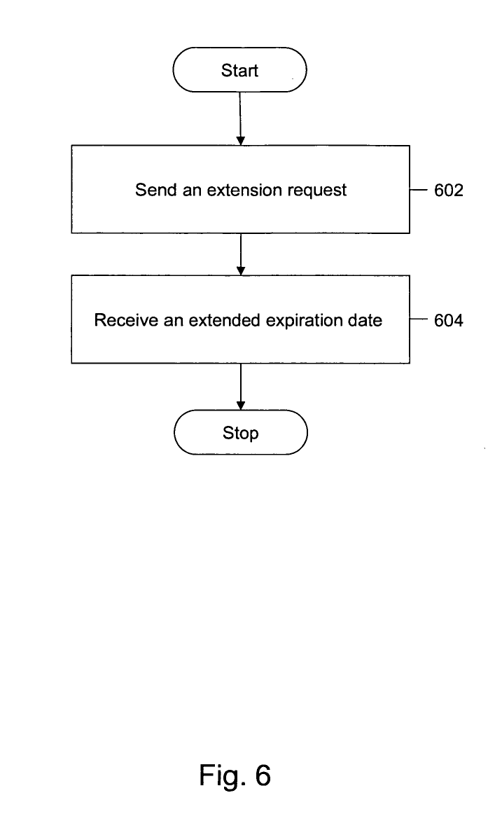

Further, compliance server 104 manages the communication for the extension of the access expiration date. According to various embodiments of the invention, compliance server 104 makes a request for the extended access expiration date to license manager 102. Thereafter, license manager 102 extends the access expiration date and communicates it to compliance server 104. Accordingly, at step 204, license manager 102 extends the access expiration date. According to the various embodiments of the invention, the access expiration date is extended beyond the expiration date of the license, when payment for the renewal of the license is due. Details pertaining to the extension of the access expiration date are explained with reference to FIG. 6.

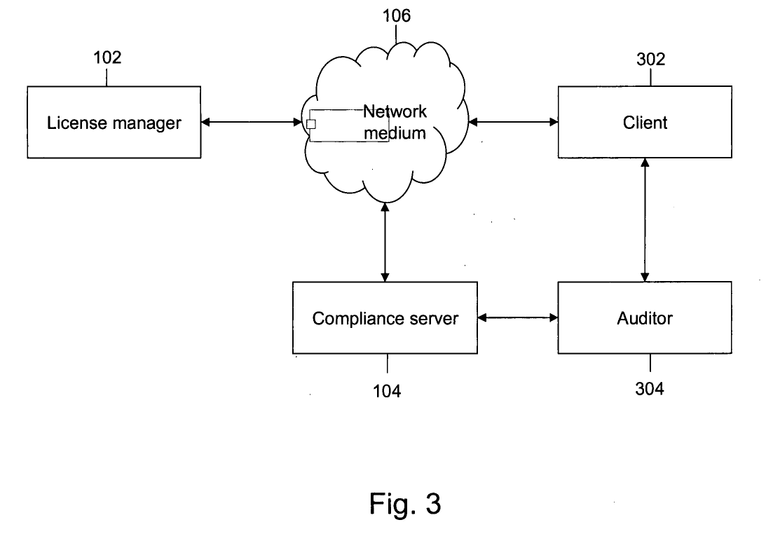

At step 206, compliance server 104 sends a compliance message indicating that payment for the license is due. According to various embodiments of the invention, the compliance message indicates the access expiration date. According to various embodiments of the invention, compliance server 104 sends the compliance message to the authorized entity. Thereafter, the authorized entity instructs the user to make payment for the license by including payment for the license as part of its functions. According to various embodiments of the invention, the functions of the authorized entity can include verification for the compliance of the user with the regulations. Further, the authorized entity reminds the user to comply with the regulations and make the payment for the license. Details pertaining to the authorized entity and the regulations are explained with reference to FIG. 3. Moreover, the authorized entity can track and keep a record of the payment amount that is due after the access expiration date of the licensed product is extended.

FIG. 3 illustrates an environment wherein an embodiment of the invention can be practiced. In addition to license manager 102 and compliance server 104, a client 302 can communicate over network medium 106. According to various embodiments of the invention, client 302 is a user. Accordingly, client 302 requires the license for the licensed product to utilize the services provided by the licensed product. For example, client 302 is a business enterprise that requires a license for a software product, which authorizes client 302 to utilize the services provided by the licensed software product. In an embodiment of the invention, to access the services provided by the licensed product, client 302 can pay for the license to the provider and is provided access to the use of the licensed product through license manager 102. Further, client 302 may be unable to pay for the renewal of the license due to certain constraints and may want to extend the access expiration date of the licensed product, when payment for the license is still due.

Extension of the access expiration date provides client 302 an extended time for which client 302 can access the licensed product. Further, client 302 has to comply with the regulations. Examples of regulations include, but are not limited to, Sarbanes-Oxley regulations, Generally Accepted Accounting Principles (GAAP), Health Insurance Portability and Accountability Act (HIPPA), Gramm-Leach-Bliley Act and the like. For example, client 102 may be a business enterprise, which may be required to comply with legislations and regulations such as the Sarbanes-Oxley regulations for corporate security, and the privacy of client 302. In accordance with the Sarbanes-Oxley regulations, client 302 needs a certificate that verifies the accuracy and reliability of the corporate disclosures and transaction records of client 302. The authorized entity can provide this certification if client 302 abides by the regulations. In an embodiment of the invention, the authorized entity can impose a penalty on client 302, if client 302 fails to comply with the regulations. In another embodiment of the invention, client 302 may have to compromise on the services provided by the licensed product, if client 302 fails to make the payment for the license. According to various embodiments of the invention, an auditor 304 is an authorized entity. According to various embodiments of the invention, auditor 304 is independent of client 302 and license manager 102 and is considered a trusted third-party by client 302 and license manager 102. For example, auditor 304 is a business enterprise that is selected by the mutual consent of client 302 and license manager 102. According to various embodiments of the invention, auditor 304 is authorized to verify that the internal records of client 302 are in accordance with auditing standards. For example, auditor 304 is a business enterprise that is responsible for auditing the financial statements of client 302. Auditing refers to an examination of activities and documents, which includes a verification of the financial records of business enterprises. Auditing of client 302 is carried out on a date referred to as a date of auditing or an audit date. According to various embodiments of the invention, auditing of client 302 includes ensuring that client 302 complies with the regulations. The regulations can be legal regulations imposed by an administrative entity through the process of rule-making, so that client 302 has to comply with it. For example, the administrative entity can be a government organization that is responsible for making the rules and regulations for business enterprises that come under its administrative jurisdiction. Non-compliance with regulations by client 302 can result in a penalty. In an embodiment of the invention, auditor 302 can be the administrative entity. In another embodiment of the invention, the administrative entity can be independent of auditor 302. According to various embodiments of the invention, auditor 304 instructs client 302 to make payment for the license by including payment for the license in its auditing functions. According to various embodiments of the invention, the auditing functions include verification of compliance of client 302 with the regulations. Further, auditor 304 reminds client 302 for the payment, as per the auditing functions. For example, auditor 304 can include payment for the license in an audit trail for client 302. The audit trail is the verification of records of transactions made by client 302. Accordingly, auditor 304 ensures that client 302 complies with the regulations on the audit date. It is to be understood that letting a software license lapse may have the consequence that a company may be out-of-compliance, and therefore the auditor's message instructing payment to be made is a condition of getting the auditor to sign off on the compliance statement.

In an embodiment of the invention, auditor 304 can be an internal auditor that is a part of client 302. For example, client 302 can be a business enterprise, which includes an auditing department that ensures that client 302 complies with the regulations, and makes payment for the license issued to client 302.

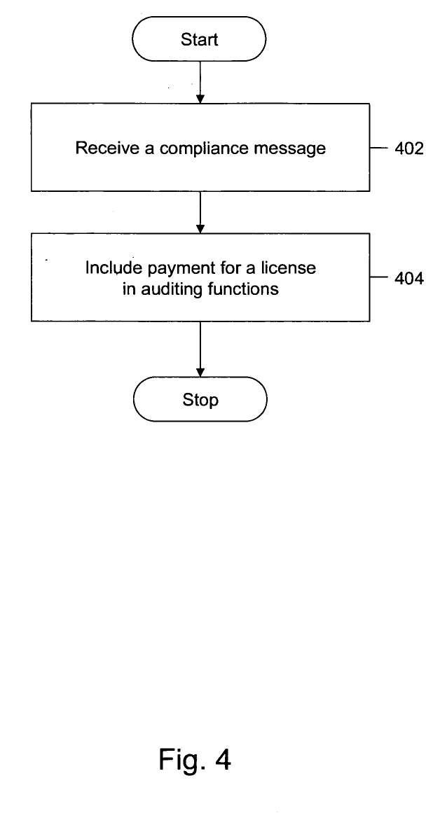

FIG. 4 is a flowchart illustrating the method to manage payment for the license, in accordance with an embodiment of the invention. At step 402, auditor 304 receives a compliance message indicating that the payment for the license is due. According to various embodiments of the invention, the compliance message indicates the expiration date of the licensed product. According to various embodiments of the invention, compliance server 104 sends the compliance message to auditor 304. For example, compliance server 104 can send an e-mail to auditor 304, which informs auditor 304 that payment for the license is to be made by client 302. Further, at step 404, auditor 304 instructs client 302 to make payment for the license by including payment for the license in the auditing functions. According to various embodiments of the invention, if the auditing functions include verification of compliance of client 302 with the regulations then, auditor 304 reminds and ensures that client 302 makes the payment for the license. For example, auditor 304 verifies transaction records pertaining to payments made by client 302. Thereafter, auditor 304 may instruct client 302 to comply with the regulations and make payment for the license. Noncompliance of client 302 with the regulations can result in the penalty for client 302. For example, if client 302 fails to comply with the regulations, then it can be subjected to a legal action. Moreover, according to various embodiments of the invention, auditor 304 can track and keep a record of the payment amount that is due after the expiration date of the licensed product is reached.

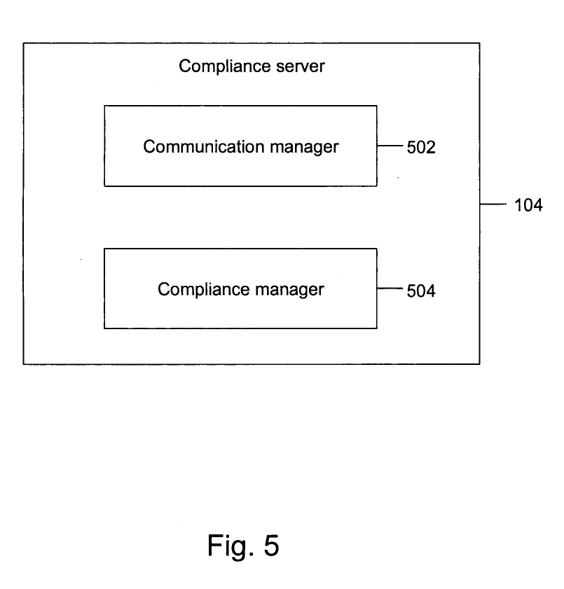

FIG. 5 illustrates compliance server 104, in accordance with an embodiment of the invention. Compliance server 104 includes a communication manager 502 a compliance manager 504. In an embodiment of the invention, communication manager 502 receives the warning message, which is sent by license manager 102. In an embodiment of the invention, communication manager 502 can be a transceiver, which is capable of receiving the warning message. In accordance with an embodiment of the invention, communication manager 502 can be an infrastructural-level or an application-level computer program, which can be embedded in compliance server 104 and is capable of receiving the warning message.

After the warning message is received, compliance server 104 manages communication for the extension of the access expiration date of the licensed product. According to various embodiments of the invention, license manager 102 extends the access expiration date. According to various embodiments of the invention, communication manager 502 manages communication for extending the access expiration date.

After the access expiration date of the licensed product is extended, compliance server 102 sends the compliance message to auditor 304. According to various embodiments of the invention, compliance manager 504 sends the compliance message. In an alternative embodiment of the invention, compliance manager 504 instructs communication manager 502 to send the compliance message to auditor 304. In an embodiment of the invention, compliance manager 504 can be an infrastructural-level or an application-level computer program, which can be embedded in compliance server 104.

FIG. 6 is a flowchart illustrating the method for the extension of the access expiration date of the licensed product, in accordance with various embodiments of the invention. At step 602, compliance server 104 sends an extension request to license manager 102, requesting an extension of the access expiration date. According to various embodiments of the invention, communication manager 502 sends the extension request to license manager 102. In an embodiment of the invention, the extension request includes the audit date. In another embodiment of the invention, the extension request can include the payment amount that is due for the licensed product. For example, communication manager 502 sends an email to license manager 102, which includes the payment amount charged per session for which the licensed product is used.

In accordance with various embodiments of the invention, after receiving the extension request, license manager 102 extends the access expiration date of the license and sends the extended access expiration date to compliance server 104. In an embodiment of the invention, an administrator of license manager 102 extends the access expiration date of the licensed product and sends the extended access expiration date to compliance server 104. According to various embodiments of the invention, license manager 102 can include a computer program, which determines the extended access expiration date based on a set of programmed parameters. For example, the set of programmed parameters can include payment due for the license, an expiry date of the license and an audit date. In an alternative embodiment, a manual application at license manager 102 can extend the access expiration date. For example, compliance server 104 sends an e-mail to an accountant that can instruct license manager 102 to extend the access expiration date.

At step 604, compliance server 104 receives the extended access expiration date. In an embodiment of the invention, communication manager 502 receives the extended access expiration date from license manager 102. In an embodiment of the invention, the extended access expiration date is a date that is later than the audit date. In an alternative embodiment of the invention, the extended access expiration date is the same as the audit date.

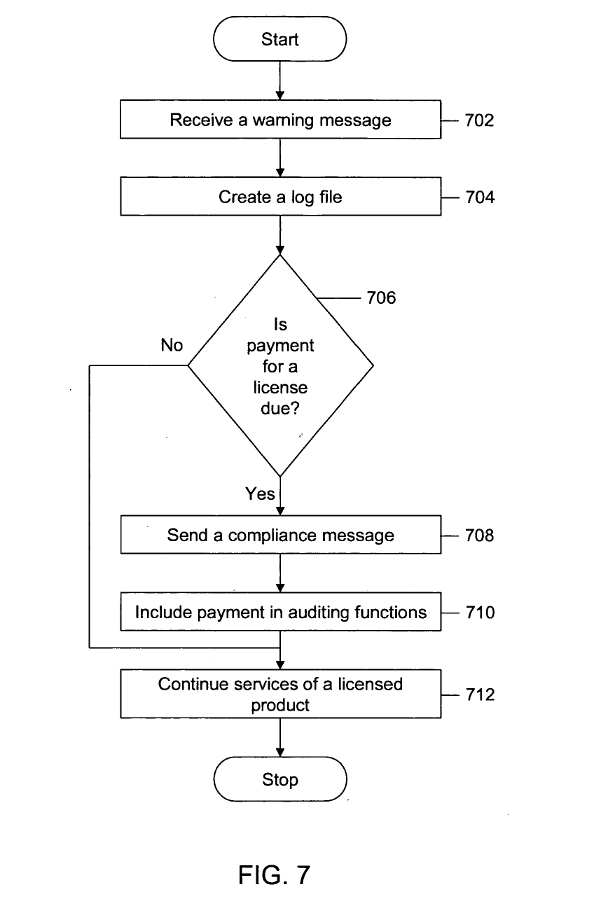

FIG. 7 is a flowchart illustrating the method for managing the use of the licensed product, in accordance with an embodiment of the invention. At step 702, compliance server 104 receives a warning message that indicates the expiration date of the license. Details pertaining to the warning message have been explained with reference to FIG. 2. At step 704, compliance server 104 creates a log file that indicates the status of payment for the license. At step 706, it is checked if payment for the license is due. According to various embodiments of the invention, compliance server 104 checks if the payment is due. At step 708, a compliance message is sent to auditor 304 indicating that the payment is due. Details pertaining to the compliance message have been explained with reference to FIG. 2. At step 710, auditor 304 instructs client 302 to make payment for the license by including the payment for the license in the auditing functions. Details pertaining to the auditing functions have been explained with reference to FIG. 3. At step 712, client 302 is able to continue use of services provided by the licensed product. According to various embodiments of the invention, client 302 is provided access to the licensed product even when the payment is due. However, auditor 304 ensures and reminds client 302 to make the payment for the license.

If at step 706, it is found that the payment is not due, client 302 is provided access to the licensed product in accordance with step 712.

Embodiments of the invention enable utilization of the services provided by the licensed product, even when payment for the license is due and the validity of the license has expired. This can be achieved by instructing client 302 to make payment by including payment for the license in the auditing functions. Thereafter, client 302 continues the use of the licensed product while auditor 304 reminds client 302 for payment in the process of performing the auditing functions. Moreover, the access expiration date of the licensed product can be extended and is communicated to auditor 304. Hence, client 302, using the services of the licensed product, can continue to utilize them for an extended period. This may be especially useful for client 302, when the licensed product is a critical product and expiration to its access can cause damage to client 302. As previously mentioned, letting a software license lapse may have the consequence that a company may be out-of-compliance, and therefore the auditor's message instructing payment to be made is a condition of getting the auditor to sign off on the compliance statement.

In accordance with various embodiments of the invention, the access of client 302 to the services provided by the licensed product never expires. Therefore, client 302 can continue to access the services even if the payment for the license is due.

In addition, in accordance with various embodiments of the invention, client 302 is instructed to make payment for the license to the provider by including payment for the license in the auditing functions. Therefore, client 302 pays the provider for the license.

Although the invention has been discussed with respect to specific embodiments thereof, these embodiments are merely illustrative, and not restrictive, of the invention.

Although specific protocols have been used to describe embodiments, other embodiments can use other transmission protocols or standards. Use of the terms ‘peer’, ‘client’, and ‘server’ can include any type of device, operation, or other process. The invention can operate between any two processes or entities including users, devices, functional systems, or combinations of hardware and software. Peer-to-peer networks and any other networks or systems where the roles of client and server are switched, change dynamically, or are not even present, are within the scope of the invention.

Any suitable programming language can be used to implement the routines of the present invention including C, C++, Java, assembly language, etc. Different programming techniques such as procedural or object oriented can be employed. The routines can execute on a single processing device or multiple processors. Although the steps, operations, or computations may be presented in a specific order, this order may be changed in different embodiments. In some embodiments, multiple steps shown sequentially in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing.

In the description herein for embodiments of the invention, numerous specific details are provided, such as examples of components and/or methods, to provide a thorough understanding of embodiments of the invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the invention.

A ‘computer’ for purposes of embodiments of the invention may include any processor-containing device, such as a mainframe computer, personal computer, laptop, notebook, microcomputer, server, personal data manager or ‘PIM’ (also referred to as a personal information manager), smart cellular or other phone, so-called smart card, set-top box, or any of the like. The communication manager, the extending manager, the compliance manager mentioned above can be computer programs wherein a ‘computer program’ may include any suitable locally or remotely executable program or sequence of coded instructions, which are to be inserted into a computer, well known to those skilled in the art. Stated more specifically, a computer program includes an organized list of instructions that, when executed, causes the computer to behave in a predetermined manner. A computer program contains a list of ingredients (called variables) and a list of directions (called statements) that tell the computer what to do with the variables. The variables may represent numeric data, text, audio or graphical images. If a computer is employed for presenting media via a suitable directly or indirectly coupled input/output (I/O) device, the computer would have suitable instructions for allowing a user to input or output (e.g., present) program code and/or data information respectively in accordance with the embodiments of the invention.

A ‘computer readable medium’ for purposes of embodiments of the invention may be any medium that can contain, store, communicate, propagate, or transport the computer program for use by or in connection with the instruction execution system apparatus, system or device. The computer readable medium can be, by way of example only but not by limitation, an electronic, magnetic, optical, electromagnetic, infrared, or semiconductor system, apparatus, system, device, propagation medium, or computer memory.

Reference throughout this specification to “one embodiment”, “an embodiment”, or “a specific embodiment” means that a particular feature, structure, or characteristic described in connection with the embodiment is included in at least one embodiment of the invention and not necessarily in all embodiments. Thus, respective appearances of the phrases “in one embodiment”, “in an embodiment”, or “in a specific embodiment” in various places throughout this specification are not necessarily referring to the same embodiment. Furthermore, the particular features, structures, or characteristics of any specific embodiment of the invention may be combined in any suitable manner with one or more other embodiments. It is to be understood that other variations and modifications of the embodiments of the invention described and illustrated herein are possible in light of the teachings herein and are to be considered as part of the spirit and scope of the invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application.

Additionally, any signal arrows in the drawings/Figures should be considered only as exemplary, and not limiting, unless otherwise specifically noted. Combinations of components or steps will also be considered as being noted, where terminology is foreseen as rendering the ability to separate or combine is unclear.

As used in the description herein and throughout the claims that follow, “a”, an and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the invention, including what is described in the abstract, is not intended to be exhaustive or to limit the invention to the precise forms disclosed herein: While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention.

Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims

What is claimed is:

1. A method for managing extension of an access expiration date of a licensed product, the method comprising
receiving a warning message indicating that payment for a license for the licensed product is due; and
managing communication pertaining to extension of the access expiration date of the licensed product based on the warning message, wherein the managing of the communication comprises sending a compliance message indicating that the access expiration date is extended.

2. The method of claim 1, wherein the licensed product is a licensed software product.

3. The method of claim 1, wherein the receiving the warning message comprises receiving the expiration date of the license.

4. The method of claim 1, wherein the receiving the warning message comprises creating a log file when the warning message is received.

5. The method of claim 1, wherein the managing the communication comprises
sending an extension request for extending the access expiration date to a license manager, the license manager managing the access to the licensed product; and
receiving the extended access expiration date from the license manager.

6. The method of claim 5, wherein the sending the extension request comprises sending a date of auditing on which financial records related to the payment for the license are verified.

7. The method of claim 5, further comprising extending the access expiration date by the license manager.

8. The method of claim 1, wherein the extended access expiration date is a date after a date of auditing on which financial records related to the payment for the license are verified.

9. The method of claim 1, wherein the extended access expiration date is identical to a date of auditing on which financial records related to the payment for the license are verified.

10. The method of claim 1, wherein the managing the communication comprises sending the compliance message to an auditor verifying financial records related to the payment for the license.

11. The method of claim 1, further comprising managing payment for the license by an auditor verifying financial records related to the payment for the license, if the compliance message is sent to the auditor.

12. The method of claim 11, wherein the managing payment for the license comprises including the payment for the license in auditing functions of the auditor.

13. A method for managing payment for a license for a licensed product, the method comprising
receiving a compliance message indicating an expiration date of the license; and
including the payment for the license in auditing functions based on the compliance message, the payment being included in the auditing functions of an auditor verifying financial records related to the payment for the license.

14. The method of claim 13, further comprising continuing providing services of the licensed product even if the payment for the license of the licensed product is due.

15. A system for managing extension of an access expiration date of a licensed product, the system comprising
means for receiving a warning message indicating that payment for a license for the licensed product is due; and
means for managing communication pertaining to extension of the access expiration date of the licensed product based on the warning message, wherein the managing communication comprises sending a compliance message indicating that the access expiration date is extended.

16. A system for managing extension of an access expiration date of a licensed product, the system comprising
a license manager for managing access to the licensed product; and
a compliance server for managing communication pertaining to extension of the access expiration date of the licensed product based on a warning message received from the license manager.

17. The system of claim 16, wherein the license manager extends the access expiration date of the licensed product.

18. The system of claim 16, wherein the compliance server comprises a communication manager for managing communication, wherein the communication comprises receiving a warning message indicating that payment for the license is due, sending an extension request for extending the access expiration date, receiving the extended access expiration date and sending a compliance message indicating that the access expiration date is extended.

19. The system of claim 16, wherein the compliance server comprises a compliance manager for sending the compliance message to an auditor verifying financial records related to the payment for the license.

20. An apparatus for managing extension of an access expiration date of a licensed product, the apparatus comprising
a processing system including a processor coupled to a display and user input device; and
a machine-readable medium including instructions executable by the processor comprising
one or more instructions for receiving a warning message indicating that payment for a license for the licensed product is due; and
one or more instructions for managing communication pertaining to extension of the access expiration date of the licensed product based on the warning message, wherein the managing communication comprises sending a compliance message indicating that the access expiration date is extended.

21. A machine-readable medium including instructions executable by the processor comprising
one or more instructions for receiving a warning message indicating that payment for a license for the licensed product is due; and
one or more instructions for managing communication pertaining to extension of the access expiration date of the licensed product based on the warning message, wherein the managing communication comprises sending a compliance message indicating that the access expiration date is extended.
